(19) United States
(12) Patent Application Publication
(10) Pub. No.: US 2014/0129957 A1
(43) Pub. Date: May 8, 2014

(54) PERSONALIZED USER INTERFACE ON MOBILE INFORMATION DEVICE

(71) Applicant: NVIDIA CORPORATION, Santa Clara, CA (US)

(72) Inventors: Li-Ling Chou, New Taipei City (TW); Yu-Li David Ho, Taipei (TW)

(73) Assignee: NVIDIA CORPORATION, Santa Clara, CA (US)

(21) Appl. No.: 13/730,070

(22) Filed: Dec. 28, 2012

(30) Foreign Application Priority Data
Nov. 2, 2012 (TW) 101140690

(51) Int. Cl. G06F 3/0482

(52) U.S. Cl. CPC G06F 3/0482
USPC 715/747

(57) ABSTRACT

A method for creating a personalized user interface on a mobile information device is provided. The method includes the steps of: filtering out from a plurality of applications APPs installed on the mobile information device one or more said applications according to a personalization filtering criterion, such as a given number of most frequently used APPs; displaying the one or more filtered APPs on a visualized menu; and executing a selected one of the one or more filtered APPs on the visualized menu in response to a selection entered by a user.

### CROSS-REFERENCE TO RELATED APPLICATIONS

This application is based on and claims the benefit of priority from Taiwan Patent Application 101140690, filed on Nov. 2, 2012, which is hereby incorporated herein by reference.

### BACKGROUND OF THE INVENTION

1. Field of the Invention

Embodiments of the present invention generally relate to a mobile information devices, and more particularly, to a user interface on a mobile information device.

2. Description of the Related Art

A conventional mobile device, such as a smart phone or a tablet, is usually equipped with a touchscreen and a graphical user interface corresponding thereto. The graphical user interface provides a background (or known as a “home screen”) configured by an operating system, such that applications (APPs) can be displayed in the form of icons in the background, allowing a user to click the touchscreen and thereby start the applications for performing operation thereon.

For more related information, please make reference to iOS operating system or Android operating system, and Apple Inc.'s iPhone or iPad.

### SUMMARY OF THE INVENTION

In an aspect, the present invention provides a personalized user interface on a mobile information device. To be portable, a conventional mobile information device is usually designed to have a small display screen; as a result, the small display screen displays a limited number of icons, and thus the other applications icons have to be displayed in the next page (or the next layer). However, in case of a plethora of applications installed in the mobile information device, a user has to search the pages for an intended application icon.

Compared with the prior art, the present invention, in an embodiment thereof, is characterized in that a user presets personalization filtering criteria for filtering out a small number of applications (whose icons can be fully displayed in a single screen, for example,) from a large number of applications, such that the user can find an intended application icon quickly.

Compared with the prior art that discloses application name-based search, the present invention, in an embodiment thereof, is characterized by personalization filtering criteria on the grounds that application names can seldom be decided or changed by a user and do not correlate with the user's operation habits or context. The concept “personalization filtering criterion/criteria” applies herein to a way of using an application by a user or usage parameters specified by the user. That is to say, given the same personalization filtering criterion, chances are that different filtering results occur because users differ in a way of using an application by a user or specify different usage parameters.

The present invention provides, in an embodiment thereof, a method for creating a personalized user interface on a mobile information device. The method comprises the steps of:
filtering out from a plurality of applications APPs installed on the mobile information device one or more said applications according to a personalization filtering criterion, such as a given number of most frequently used APPs;
displaying the one or more filtered APPs on a visualized menu; and
executing a selected one of the one or more filtered APPs on the visualized menu in response to a selection entered by a user.

The present invention provides, in another embodiment thereof, a mobile information device, comprising:
a touch control display unit;
a memory unit for storing a plurality of applications and a personalized user interface management application; and
a central processing unit electrically connected to the memory device for executing a plurality of applications and the personalized user interface management application,
   wherein the personalized user interface management application stores a personalization filtering criterion set by a user and adapted for use with the plurality of applications, such that, when executed, the personalized user interface management application filters out one or more said applications from the plurality of applications according to the personalization filtering criterion and displays the one or more filtered applications on a visualized menu of the touch control display unit for the user to further select the one or more applications thus filtered and displayed.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a block diagram of hardware architecture of a mobile information device according to an embodiment of the present invention;

FIG. 2 is a flow chart of a method according to an embodiment of the present invention;

FIG. 3 is a schematic view of a menu of filtering criteria according to an embodiment of the present invention; and

FIG. 4 is a schematic view of a menu of applications according to an embodiment of the present invention.

### DETAILED DESCRIPTION

The present invention is described below with reference to flowchart illustrations and/or block diagrams of methods, apparatus, devices, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

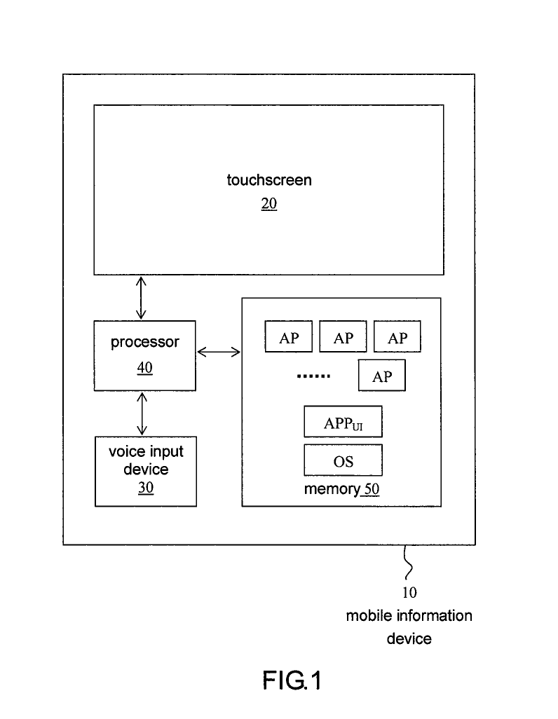

Referring now to FIG. 1 through FIG. 4, mobile information devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### Hardware Architecture

Referring to FIG. 1, there is shown a block diagram of hardware architecture of a mobile information device 10 according to an embodiment of the present invention. The mobile information device 10 comprises a touchscreen 20, a voice input device 30, a processor 40, and a memory 50. Preferably, the memory 50 is a flash memory for storing applications APP₁-APPₙ, a personalized user interface management application APP_{UI}, and an operating system OS of the mobile information device 10. The processor 40 accesses the memory 50 to execute the operating system OS, the applications APP₁-APPₙ, and the personalized user interface management application APP_{UI}.

In this embodiment, unlike the operating system OS, all the applications APP₁-APPₙ and the personalized user interface management application APP_{UI} are stand-alone applications. However, in another embodiment, the applications APP₁-APPₙ and the personalized user interface management application APP_{UI} are integrated with the operating system OS. For more information about the mobile information device 10 and hardware architecture irrelevant to the present invention, please make reference to Apple Inc.″s products, such as iPhone or iPad.

### Process Flow

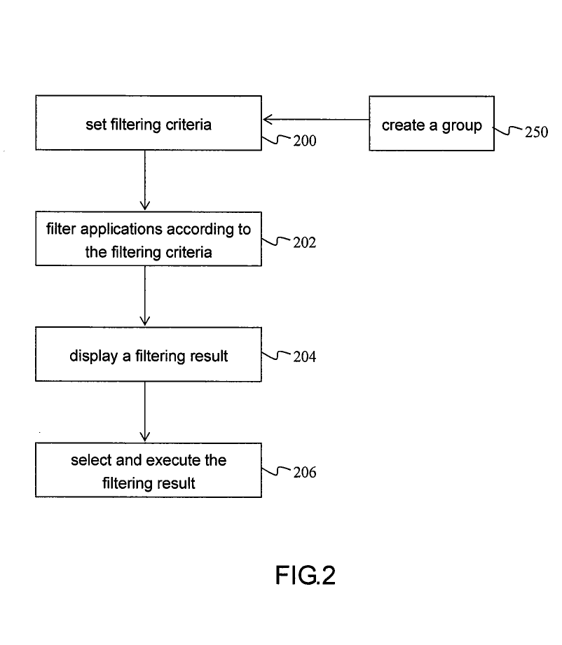

FIG. 2, which is a flow chart of a method according to an embodiment of the present invention, illustrates the present invention concisely in conjunction with FIG. 1.

Step 200: a personalized user interface management application APP_{UI} provides a setting environment for a user to set one or more personalization filtering criteria. In an exemplary embodiment, an example of the personalization filtering criteria is a given number of most frequently used applications. In this regard, the user can further define the number (such as “six”) of applications subject to the filtering criteria and calculate the time and duration of the filtering process (such as “in one month”.)

In another embodiment, prior to step 200, the personalized user interface management application APP_{UI} permits the user to create groups of applications beforehand (step 250), for example, by setting the group names to “working” and “social”, respectively, including the applications APP₁, APP₂ in the “working” group, and including the applications APP₁, APP₃ in the “social” group. The user can take the liberty of creating or deleting any group, naming any group, including any application in any group, and removing any application from any group. Furthermore, an application can be simultaneously included in at least two groups. For instance, in the exemplary embodiment, the application APP₁ belongs to both the “working” group and the “social” group. In another embodiment, although the name of a group (such as “working” or “social”) can be provided by the personalized user interface management application APP_{UI}, the user has to take the initiative in including any required application in the group.

After creating the “working” group and the “social” group, the user can treat one of the groups as a personalization filtering criterion in step 200. For example, if the “working” group serves as the filtering criterion, the applications (the applications APP₁, APP₂) included in the “working” group are the target applications to be filtered out. Likewise, if the “social” group serves as the filtering criterion, the applications (the applications APP₁, APP₃) included in the “social” group are the target applications to be filtered out. The results yielded by the two filtering criteria, namely the “working” group and the “social” group, respectively, comprise the application APP₁. Therefore, the two filtering criteria are not mutually exclusive. However, in another embodiment, it is feasible to set mutually exclusive filtering criteria.

In the exemplary embodiment, although the personalized user interface management application APP_{UI} provides a setting environment for the user to set filtering criteria, the present invention is not limited thereto. In another exemplary embodiment, filtering criteria are set in an environment provided by the other applications or in an environment outside the mobile information device 10 and then sent to the personalized user interface management application APP_{UI} for storing.

Step 202: preferably, the personalized user interface management application APP_{UI} are daemons executed in the background. The personalized user interface management application APP_{UI} is started as soon as a user need is identified, so as to filter the applications APP₁-APPₙ according to the filtering criteria.

Then, the user performs a specific operation on the touchscreen 20 so as for the personalized user interface management application APP_{UI} to start filtering. In an embodiment, the user can triple-click any point on the touchscreen 20 or click a specific point (such as the lower left corner) on the touchscreen 20 to start the personalized user interface management application APP_{UI} for filtering applications according to the “most frequently used” filtering criteria. In another embodiment, the user can perform sliding along a W-shaped track on the touchscreen 20 so as for the personalized user interface management application APP_{UI} to start filtering the “working” group, or the user can perform sliding along an S-shaped track on the touchscreen 20 so as for the personalized user interface management application APP_{UI} to start filtering the “social” group. Afterward, step 204 begins.

In addition to performing an operation on the touchscreen 20, the user may enter a specific voice instruction with the voice input device 30, so as to start the personalized user interface management application APP_{UI} for filtering applications.

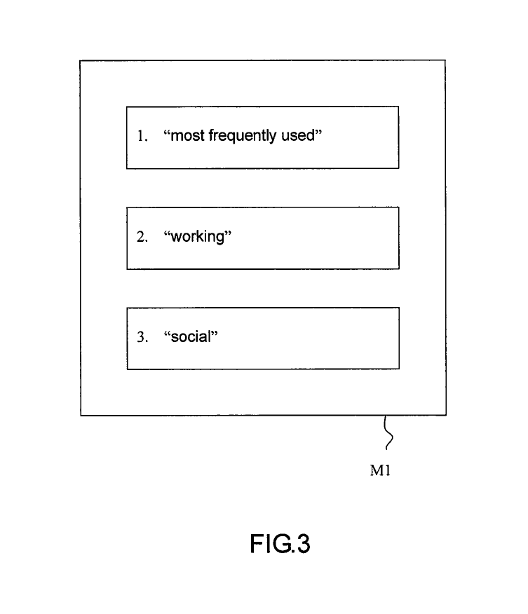

In the situation where the personalized user interface management application APP_{UI} are not daemons running in the background, the user may click on specific icons provided by the personalized user interface management application APP_{UI} or press a physical button (which are not shown in FIG. 1) on the mobile information device 10 in order to execute the personalized user interface management application APP_{UI}. When executed, the personalized user interface management application APP_{UI} provides a menu M1 (shown in FIG. 3) that displays all stored filtering criteria (such as “most frequently used”, “working” group, and “social” group), such that the user can select one of the filtering criteria on the menu M1 for filtering applications.

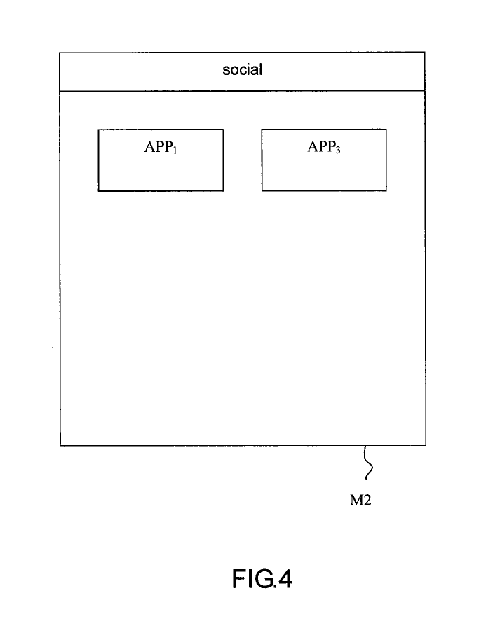

Step 204: after the personalized user interface management application APP_{UI} has finished filtering applications according to the filtering criteria, the one or more filtered applications can be displayed on a visualized menu. For example, if the filtering criterion is “social” group, the personalized user interface management application APP_{UI} will display the icons of the applications APP₁, APP₃, (i.e., the filtering results) on a menu M2 (shown in FIG. 4), such that the user can further select the icons of the applications APP₁, APP₃. If the filtering criterion is “most frequently used”, the personalized user interface management application APP_{UI} might have to communicate with the operating system OS in order to fetch a log of access to each application on the mobile information device 10 and further calculate the frequency of using each application.

Step 206: execute a selected application in response to a selection entered into the menu M2 by the user. For example, the user clicks on the icon of the application APP₃ on the menu M2, so as to execute the application APP₃ on the mobile information device 10.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

1. A method for creating a personalized user interface on a mobile information device, the method comprising the steps of:
filtering out one or more applications, from a plurality of applications installed on the mobile information device, according to a personalization filtering criterion;
displaying the one or more applications on a visualized menu; and
executing a selected one of the one or more filtered applications on the visualized menu in response to a selection entered by a user.

2. The method of claim 1, wherein the personalization filtering criterion is frequently used applications.

3. The method of claim 1, wherein the personalization filtering criterion is user-pre-selected applications.

4. The method of claim 1, wherein the filtering further comprises beginning the filtering in response to a user performing a specific operation on a touch control display unit.

5. The method of claim 4, wherein the specific operation on a touch control display comprises the user touching a specific point on the touch control display unit.

6. The method of claim 4, wherein the specific operation on a touch control display comprises the user sliding along a specific track on the touch control display unit.

7. The method of claim 1, further comprising selecting the personalization filtering criterion from a plurality of personalization filtering criteria previously set by the user and adapted for use with the plurality of applications.

8. The method of claim 7, wherein the plurality of personalization filtering criteria are not mutually exclusive.

9. The method of claim 7, wherein selecting the personalization filtering criterion further comprises selecting a personalization filtering criterion based on a user performing a specific operation on the touch control display unit.

10. A computer-readable medium storing instructions, that when executed by a processor, cause a computer system to create a personalized user interface on a mobile information device, by performing the steps of:
filtering out one or more applications, from a plurality of applications installed on the mobile information device, according to a personalization filtering criterion;
displaying the one or more applications on a visualized menu; and
executing a selected one of the one or more filtered applications on the visualized menu in response to a selection entered by a user.

11. The compute-readable medium of claim 10, wherein the personalization filtering criterion is frequently used applications.

12. The computer-readable medium of claim 10, wherein the personalization filtering criterion is user-pre-selected applications.

13. The computer-readable medium of claim 10, wherein the filtering further comprises beginning the filtering in response to a user performing a specific operation on a touch control display unit.

14. The computer-readable medium of claim 13, wherein the specific operation on a touch control display comprises the user touching a specific point on the touch control display unit.

15. The computer-readable medium of claim 13, wherein the specific operation on a touch control display comprises the user sliding along a specific track on the touch control display unit.

16. The computer-readable medium of claim 10, further comprising selecting the personalization filtering criterion from a plurality of personalization filtering criteria previously set by the user and adapted for use with the plurality of applications.

17. The computer-readable medium of claim 16, wherein the plurality of personalization filtering criteria are not mutually exclusive.

18. The computer-readable medium of claim 16, wherein selecting the personalization filtering criterion further comprises selecting a personalization filtering criterion based on a user performing a specific operation on the touch control display unit.

19. A mobile information device, comprising:
a touch control display unit;
a processor coupled to the touch control display unit; and
a memory coupled to the processor, wherein the memory includes an application having instructions that, when executed by the processor, cause the processor to:
filter out one or more applications, from a plurality of applications installed on the mobile information device, according to a personalization filtering criterion,
display the one or more applications on a visualized menu, and
execute a selected one of the one or more filtered applications on the visualized menu in response to a selection entered by a user.

20. The mobile information device of claim 19, wherein the memory further includes instructions that, when executed by the processor, cause the processor to select the personalization filtering criterion from a plurality of personalization filtering criteria previously set by the user and adapted for use with the plurality of applications.
